(19) United States
(12) Patent Application Publication
(10) Pub. No.: US 2002/0001850 A1
(43) Pub. Date: Jan. 3, 2002

(54) METHOD FOR AUTOMATICALLY ADJUSTING CONCENTRATION OF SOLUTION USED IN SEMICONDUCTOR MANUFACTURING PROCESS

(76) Inventors: JUI-PING LI, SANSHING SHIANG (TW); CHIEN-HUNG CHEN, YUNGHE CITY (TW); PEI-FENG SUN, KAOHSIUNG (TW); MAY-JANE CHEN, SHINJUANG CITY (TW)

Correspondence Address: DIKE, BRONSTEIN, ROBERTS & CUSHMAN, INTELLECTUAL PROPERTY PRACTICE GROUP, EDWARDS & ANGELL, P.O. BOX 9169, BOSTON, MA, 02209, US

(21) Appl. No.: 09/305,605

(22) Filed: May 5, 1999

(30) Foreign Application Priority Data
Feb. 2, 1999 (TW) 88101595

(51) Int. Cl. G01N 31/00

(52) U.S. Cl. 436/55; 134/2; 422/62

(57) ABSTRACT

A method for automatically adjusting a concentration of a solution having a first component and a second component, used in a semiconductor manufacturing process, includes the steps of (a) providing target concentrations of the first component and the second component, (b) adjusting the concentration of the solution based on the first component by adding a first spiking amount of the first component during a first spiking time interval, and (c) adjusting the first spiking amount of the first component until a first deviation between an actual concentration of the first component and the target concentration of the first component is smaller than a first specific percentage. The method further includes steps of (d) adjusting the concentration of the solution based on the second component by adding a second spiking amount of the second component during a second spiking time interval, (e) adjusting the second spiking amount of the second component until a second deviation between an actual concentration of the second component and the target concentration of the second component is smaller than a second specific percentage, and (f) readjusting the concentration of the solution until the first and the second deviation are respectively smaller than the first and second specific percentage.

### FIELD OF THE INVENTION

The present invention relates to a method for adjusting a concentration of a solution, and more particularly to a method for automatically adjusting a concentration of a solution used in a semiconductor manufacturing process.

### BACKGROUND OF THE INVENTION

In the semiconductor manufacturing process, a large amount of solution is used in the etching and cleaning steps. An APM solution composed of deionized water, ammonium hydroxide, and hydrogen peroxide is used widely. However, the change in concentrations of ammonium hydroxide and hydrogen peroxide may influence the yield of the wafer. For example, as the concentration of ammonium hydroxide is too high, the etching rate of the solution will become higher, resulting in that the roughness of the wafer surface is too large and oxide lose. On the other hand, when the concentration of the ammonium hydroxide is too low, the pH value of the solution is lowered, and then the ability of removing particles on the wafer becomes poor.

Usually, in the APM solution, the ratio of ammonium hydroxide/hydrogen peroxide/deionized water is ranged from 1:1:5 to 1:2:100. The temperature of the solution is ranged from 30° C. to 90° C. Because ammonium hydroxide is a volatile reagent, the concentration of ammonium hydroxide is decreased when the temperature is elevated. As the temperature becomes higher, the concentration of ammonium hydroxide will be reduced quickly. The clean ability of the solution will be influenced. Referring to FIG. 1 which is a concentration v.s. time plot showing the change in concentration of an APM solution along with an increased time without spiking at 70° C. The concentrations of ammonium hydroxide and hydrogen peroxide are respectively recorded in FIG. 1. As time goes by, the concentration of ammonium hydroxide is significantly reduced but that of hydrogen peroxide is much steady.

In order to maintain the steady concentrations of ammonium hydroxide and hydrogen peroxide, a “spiking” step is executed during the cleaning process. The spiking step is to respectively replenish ammonium hydroxide and hydrogen peroxide during each spiking time interval. For example, 80 ml ammonium hydroxide is added into the APM solution per 300 seconds and 30 ml hydrogen peroxide is added therein per 1200 seconds. The time interval and the spiking amount depend on the concentrations of the components in the APM solution. However, there is no method for automatically adjusting the concentration of APM solution in the prior art. When an operator is going to set up a new machine, change a new solution, or keep the stability of the cleaning solution, the operator can only control the concentration of the APM solution by a “try & error” method. The operator must test several conditions and find out a best spiking amount for adjusting the concentration of APM solution. That will waste a lot of time. So, it is tried by the applicant to solve the problem encountered with the prior art.

### SUMMARY OF THE INVENTION

Therefore, the major object of the present invention is to provide a method for automatically adjusting a concentration of a solution, having a first component and a second component, used in a semiconductor manufacturing process.

According to the present invention, the method includes the steps of (a) providing target concentrations of the first component and the second component, (b) adjusting the concentration of the solution based on the first component by adding a first spiking amount of the first component during a first spiking time interval, and (c) adjusting the first spiking amount of the first component until a first deviation between an actual concentration of the first component and the target concentration of the first component is smaller than a first specific percentage to allow that the actual concentration of the first component approaches the target concentration of the first component. The method further includes steps of (d) adjusting the concentration of the solution based on the second component by adding a second spiking amount of the second component during a second spiking time interval, (e) adjusting the second spiking amount of the second component until a second deviation between an actual concentration of the second component and the target concentration of the second component is smaller than a second specific percentage to allow that the actual concentration of the second component approaches the target concentration of the second component, and (f) readjusting the concentration of the solution until the first and the second deviation are respectively smaller than the first and second specific percentage.

Before the step (a), the method further includes steps of providing a standard solution including the first and second component at a given initial concentration and a specific temperature, and recording concentration drops of the first and second component as a function of time at the specific temperature for 8 to 24 hours without adding the first and second components. According to the present invention, the solution is a cleaning solution. The first component is ammonium hydroxide and the second component is hydrogen peroxide.

The first spiking time interval and the first spiking amount of the first component are determined by the concentration drop of the first component as a function of time corresponding to the standard solution. The first spiking time interval of the first component is ranged from 100 to 1200 seconds. The first spiking amount of the first component is ranged from 20 to 300 ml.

The second spiking time interval and the second spiking amount of the second component are determined by the concentration drop of the second component as a function of time corresponding to the standard solution. The second spiking time interval of the second component is ranged from 600 to 6000 seconds. The second spiking amount of the second component is ranged from 10 to 100 ml.

According to the present invention, the first spiking amount of the first component is increased in a first instance and decreased in a second instance to allow that an actual concentration of the first component is equal to the target concentration of the first component. In addition, the second spiking amount of the second component is increased in a first instance and decreased in a second instance to allow that an actual concentration of the second component is equal to the target concentration of the second component.

After the step (b), the method according to the present invention further includes steps of calculating the first deviation between the actual concentration and the target concentration of the first component and monitoring the first deviation between the actual concentration and the target concentration of the first component. After the step (e), the method further includes steps of calculating the second deviation between the actual concentration and the target concentration of the second component and monitoring the second deviation between the actual concentration and the target concentration of the second component. Besides, before the step (f), the method includes a step of checking whether the first deviation and the second deviation are respectively smaller than the first specific percentage and the second percentage. Certainly, the method is executed and controlled by a computer program.

The present invention may best be understood through the following description with reference to the accompanying drawings, in which:

### BRIEF DESCRIPTION OF THE DRAWINGS

FIG. 1 is a plot showing the change in concentrations of ammonium hydroxide and hydrogen peroxide in an APM solution without spiking at 70° C. as time increases;

FIG. 2 is a plot showing the spiking amount of the cleaning solution v.s. time interval;

FIG. 3 is a plot showing different spiking amounts of the cleaning solution at different temperatures (T1 is 35° C. and T2 is 70° C.);

FIG. 4 is a block diagram showing steps of the adjusting method of the present invention;

FIG. 5 is a plot showing the change in concentration of ammonium hydroxide after the spiking process.

### DETAILED DESCRIPTION OF THE PREFERRED EMBODIMENTS

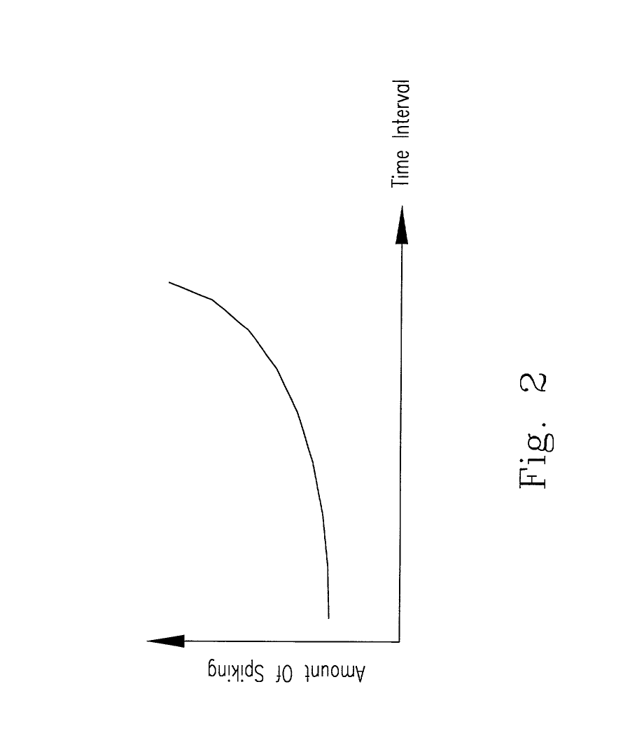

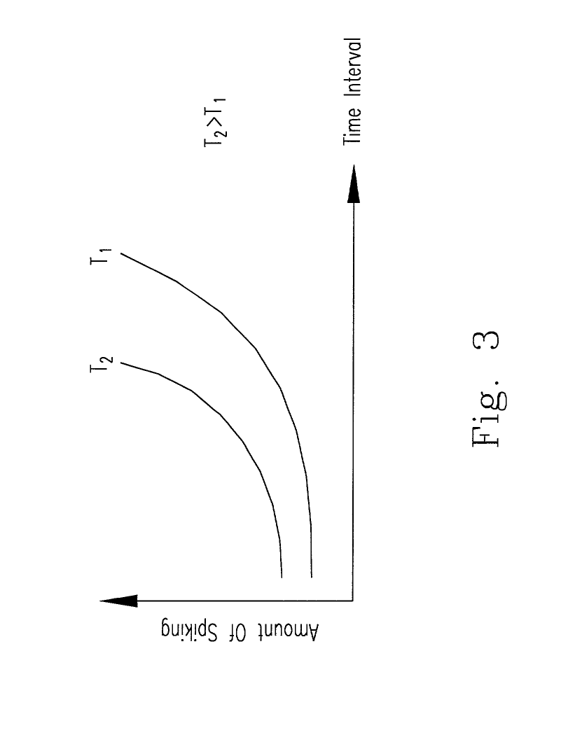

Referring to FIG. 2 which is a plot showing the spiking amount of the APM solution v.s. time interval. The spiking amount of the APM solution depends on the spiking time interval. In addition, the temperature may influence the spiking amount. Please refer to FIG. 3 which shows different spiking amounts of the APM solution at different temperatures. In FIG. 3, T₁ is 35° C. and T₂ is 70° C. When the temperature is elevated, the spiking amount of the APM solution is increased.

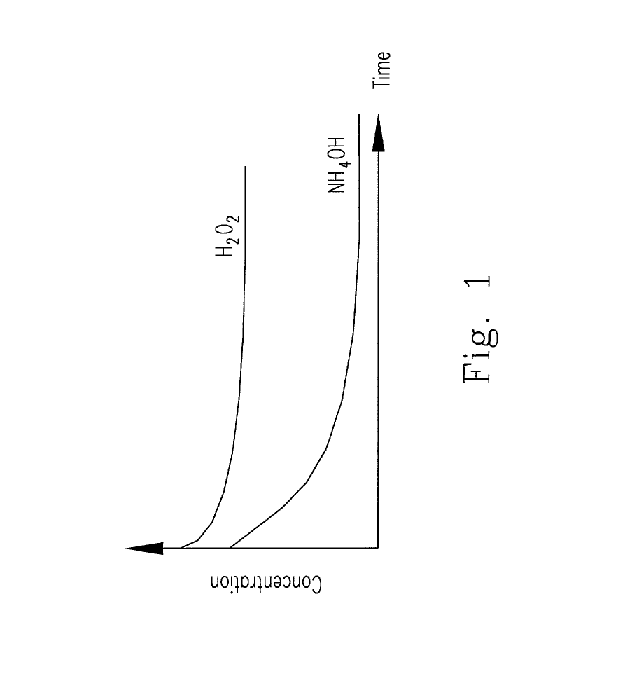

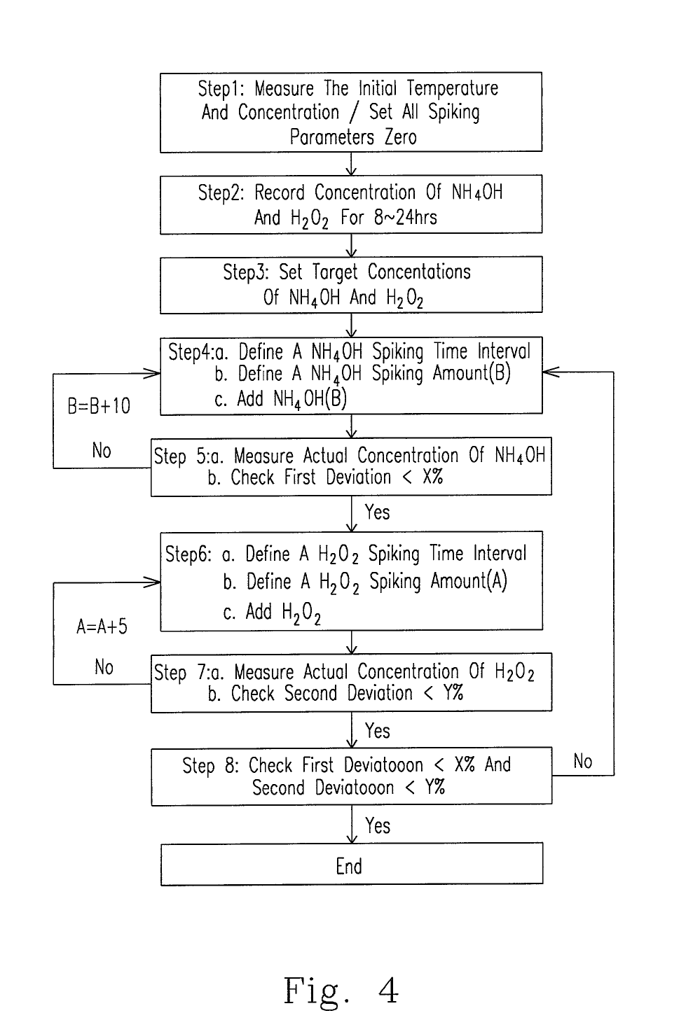

The steps of the method for automatically adjusting the concentration of the APM solution are shown in FIG. 4. First of all, the initial temperature and concentration of the APM solution are measured. All spiking parameters are zero in Step 1. There are two reagents in the APM solution including ammonium hydroxide and hydrogen peroxide. In Step 2, concentration drops of ammonium hydroxide and hydrogen peroxide as a function of time at the initial temperature are recorded for 8 to 24 hours without adding any ammonium hydroxide and hydrogen peroxide. The result is shown in FIG. 1.

In Step 3, the target concentration of ammonium hydroxide and hydrogen peroxide are set. In Step 4, a first spiking time interval of ammonium hydroxide is defined according to FIG. 2. First, the concentration of ammonium hydroxide is adjusted. The first spiking time interval of ammonium hydroxide is ranged from 100 to 1200 seconds. Further, a spiking amount of ammonium hydroxide (B) is added to the APM solution during the first spiking time interval. There is no supplement of hydrogen peroxide in this step. The spiking amount of ammonium hydroxide is ranged from 20 to 300 ml. In the preferred embodiment of the present invention, the spiking amount of ammonium hydroxide is defined as 20 ml first.

In Step 5, the actual concentration of ammonium hydroxide is measured and then a first deviation between the actual concentration and the target concentration of ammonium hydroxide can be calculated. If the first deviation is greater than X% (i.e. X=10), then the spiking amount of ammonium hydroxide is increased or reduced by a constant amount, such as 10 ml, in a time., Therefore, the spiking amount of ammonium hydroxide is adjusted during each spiking time interval of ammonium hydroxide until the first deviation is smaller than X%.

In Step 6, a second spiking time interval of hydrogen peroxide is defined. The second spiking time interval of hydrogen peroxide is ranged from 600 to 6000 seconds. Further, a spiking amount of hydrogen peroxide (A) is added into the APM solution during the second spiking time interval. The spiking amount of ammonium hydroxide is ranged from 10 to 100 ml. In the preferred embodiment of the present invention, the spiking amount of ammonium hydroxide is defined as 10 ml first.

In Step 7, the actual concentration of hydrogen peroxide is measured and then a second deviation between the actual concentration and the target concentration of hydrogen peroxide will be calculated. If the second deviation is greater than Y% (i.e. Y=10), then the spiking amount of hydrogen peroxide is increased or decreased by a constant amount, such as 5 ml, in a time. Therefore, the spiking amount of hydrogen peroxide is adjusted during each spiking time interval of hydrogen peroxide until the second deviation is smaller than Y%. Finally, in Step 8, it should be checked that the first deviation is smaller than X% and the second deviation is smaller than Y%. If one of these deviations is too large, then Step 4 to Step 8 will be repeated again for adjusting the concentration of APM solution.

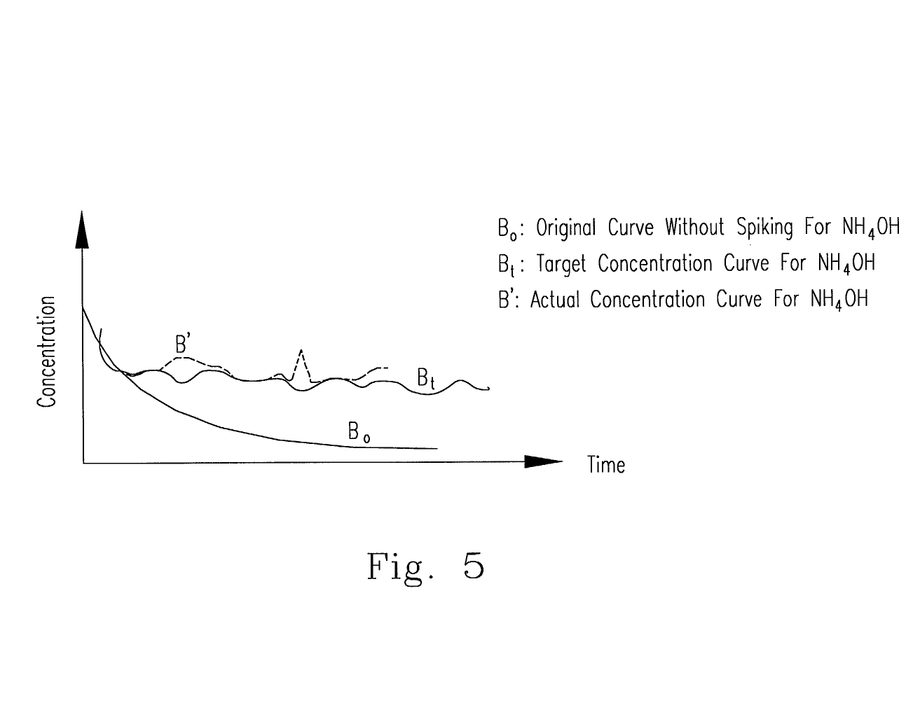

According to the method described above, the concentrations of ammonium hydroxide and hydrogen peroxide in the APM solution can be controlled well to obtain high accuracy. Referring to FIG. 5, the difference between the target concentration and the actual concentration of ammonium hydroxide is small. Besides, the method can be automatically executed and controlled by a computer program. Therefore, it can save a lot of time for adjusting the concentration of cleaning solution and the error caused by the adjusting worker can be eliminated.

While the invention has been described in terms of what are presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for automatically adjusting a concentration of a solution used in a semiconductor manufacturing process, wherein said solution comprises a first component and a second component, comprising steps of:
(a) respectively providing target concentrations of said first component and said second component;
(b) adjusting said concentration of said solution based on said first component by adding a first spiking amount of said first component during a first spiking time interval;
(c) adjusting said first spiking amount of said first component until a first deviation between an actual concentration of said first component and said target concentration of said first component is smaller than a first specific percentage to allow that said actual concentration of said first component approaches said target concentration of said first component;
(d) adjusting said concentration of said solution based on said second component by adding a second spiking amount of said second component during a second spiking time interval;
(e) adjusting said second spiking amount of said second component until a second deviation between an actual concentration of said second component and said target concentration of said second component is smaller than a second specific percentage to allow that said actual concentration of said second component approaches said target concentration of said second component; and
(f) readjusting said concentration of said solution until said first and said second deviation are respectively smaller than said first and second specific percentage.

2. The method according to claim 1, before said step (a), further comprising steps of:
providing a standard solution including said first and said second component at a given initial concentration and a specific temperature; and
recording concentration drops of said first and said second component as a function of time at said specific temperature for 8 to 24 hours without adding said first and second components.

3. The method according to claim 2 wherein said first spiking time interval and said first spiking amount of said first component are determined by said concentration drop of said first component as a function of time.

4. The method according to claim 3 wherein said first spiking time interval of said first component is ranged from 100 to 1200 seconds.

5. The method according to claim 3 wherein said first spiking amount of said first component is ranged from 20 to 300 ml.

6. The method according to claim 2 wherein said second spiking time interval and said second spiking amount of said second component are determined by said concentration drop of said second component as a function of time.

7. The method according to claim 6 wherein said second spiking time interval of said second component is ranged from 600 to 6000 seconds.

8. The method according to claim 6 wherein said second spiking amount of said second component is ranged from 10 to 100 ml.

9. The method according to claim 1 wherein said solution is a cleaning solution.

10. The method according to claim 9 wherein said first component is ammonium hydroxide and said second component is hydrogen peroxide.

11. The method according to claim 1 wherein said first spiking amount of said first component is increased in a first instance and decreased in a second instance to allow that an actual concentration of said first component is equal to said target concentration of said first component.

12. The method according to claim 1 wherein said second spiking amount of said second component is increased in a first instance and decreased in a second instance to allow that an actual concentration of said second component is equal to said target concentration of said second component.

13. The method according to claim 1, after said step (b), further comprising steps of:
calculating said first deviation between said actual concentration and said target concentration of said first component; and
monitoring said first deviation between said actual concentration and said target concentration of said first component.

14. The method according to claim 1, after said step (e), further comprising steps of:
calculating said second deviation between said actual concentration and said target concentration of said second component; and
monitoring said second deviation between said actual concentration and said target concentration of said second component.

15. The method according to claim 1, before said step (f), comprising a step of checking whether said first deviation and said second deviation are respectively smaller than said first specific percentage and said second percentage.

16. The method according to claim 1 wherein said method is executed and controlled by a computer program.
